(19) United States
(12) Patent Application Publication
(10) Pub. No.: US 2021/0319523 A1
(43) Pub. Date: Oct. 14, 2021

(54) METHODS, DEVICES, FINANCIAL INSTRUMENTS, AND SYSTEMS FOR FACILITATING FARM LENDING

(71) Applicant: Nicholas J. Swenson, Minneapolis, MN (US)

(72) Inventor: Nicholas J. Swenson, Minneapolis, MN (US)

(21) Appl. No.: 17/224,657

(22) Filed: Apr. 7, 2021

Related U.S. Application Data
(60) Provisional application No. 63/007,520, filed on Apr. 9, 2020.

(51) Int. Cl. G06Q 50/02; G06Q 40/02; G06Q 30/02

(52) U.S. Cl. CPC G06Q 50/02; G06Q 30/0278; G06Q 40/025

(57) ABSTRACT

Methods, devices, financial instruments, and systems for facilitating farm lending are described herein. One financial instrument includes a principal loan amount based on the valuation of a parcel of property and a farm crop based variable loan amount based on price for a farm crop on a farm crop index.

### PRIORITY INFORMATION

This application claims priority to U.S. Provisional Application No. 63/007,520 filed Apr. 9, 2020, the specification of which is incorporated herein by reference.

### TECHNICAL FIELD

The present disclosure relates to methods, devices, financial instruments, and systems for facilitating farm lending.

### BACKGROUND

Lending structures for farmers currently can put the farmer in a difficult position if crop prices drop. In such structures, the farmer must put up a large amount of collateral and if the farmer is forced to default, they could lose the farm and the collateral which may not allow them to continue farming.

In particular, if they want to refinance or purchase a piece of property, the farmer typically needs to post 50% of the property's value and sign a personal guarantee that they will pay the remainder. These loans are interest rate products where the interest rate is either fixed or variable based on changes to the prime interest rate and, thereby, the farmer may not be able to meet the terms crop prices drop and/or may be vulnerable to rising interest rates.

From an investor's perspective, if an investor wanted to add some farm land based investments to their portfolio, currently, they have few options. For example, they could purchase the farm land themselves, but this is an illiquid asset that may be hard to sell in the future and requires a large investment, which limits who could invest under this scenario. There is also no way to scale the investor's exposure to risk as they are “all in” on the property as the owner.

In some areas, another option is a farm based real estate investment trust. However, this is not an option in states that outlaw large corporate farm ownership, such as Minnesota and Iowa, and does not reduce or realign the risk to the farmer, just for the investors.

### BRIEF DESCRIPTION OF THE DRAWINGS

FIG. 1 illustrates an example of the components of a financial instrument for facilitating farm lending according to one or more embodiments of the present disclosure.

FIG. 2 illustrates an example of a method for facilitating farm lending according to one or more embodiments of the present disclosure.

FIG. 3 illustrates a system for facilitating farm lending according to one or more embodiments of the present disclosure.

FIG. 4 illustrates sets of executable instructions and data that can be used to provide the functionalities according to one or more embodiments of the present disclosure.

FIG. 5 illustrates an example of a computer readable medium having a set of executable instructions for facilitating farm lending according to one or more embodiments of the present disclosure.

FIG. 6 illustrates a system that provides data and executable instructions for creating a financial instrument according to embodiments of the present disclosure.

### DETAILED DESCRIPTION

As discussed above, the embodiments of the present disclosure relate to methods, devices, financial instruments, and systems for facilitating farm lending. Such an implementation allows the farmer and investors to align their risk by associating the payment calculus with the farm economy, among other benefits.

For example, the embodiments of the present disclosure provide better options because the farmers may not need to post as much capital. The financial products of the present disclosure also more closely mirror the economic performance of the farm land. Through use of embodiments of the present disclosure, in some implementations, a public equity can be created that would effectively give investors exposure to the performance of the farm land. This solves several problems. For example, the farmers get more efficient credit and investors are able to own a security that gives them scalable diversified exposure to farmland as portfolio holding.

The financial products discussed in the present disclosure have several unique elements. These elements can be better understood in view of an example of a farming based financial scenario and, so, such an example is provided below.

In this example, there is a farmer that would like to buy or refinance a piece of land, and finance 50% of it. The land, in this example, is a 200 acre lot and the farmer (loan applicant) is financing 100 acres at $10,000 per acre which is equal to a $1,000,000 loan with a 10 year term.

Under a simple lending scenario, the farmer is paying down 10 acres of farm land every year on a flat amortization schedule. This is the first component of a financial product described herein.

In a second component of a financial product of the present disclosure, the lender (e.g., bank, investor, investment group, etc.) will ask the farmer to pay the lender the monetary equivalent to a fixed number of bushels of a crop (e.g., corn) per acre that is financed.

In this manner, in year 1, the calculus would be x number of bushels per acre for 100 acres. In year 2, this calculus would change to x number of bushels per acre for 90 acres because the farmer had paid down 10 acres of land in year 1 based on the flat amortization schedule. This will continue until the principal on all of the acres has been paid.

In this way, the farmer has a variable component to the amount they would pay yearly that fluctuates with the economy of the crop they are benchmarking the loan on. They also amortize the loan at 10 acres a year, so they reduce the amount of land being subject to the loan, for purposes of bushel calculation, each year the loan progresses.

From the investor's perspective, the investor would get payment for the 10 acres of land and the cash equivalent to a benchmark price for a crop that could be planted on the number of acres that is subject to the loan for that year. This cash equivalent to crop value could be used instead of a traditional fixed or variable interest rate, for example, benchmarked off the prime interest rate which has no correlation to the price of crops. This can enable the farmer to be able to pay for his/her farm land more easily because the amount they pay will be lower in poor farm economic times and higher in good farm economic times.

So, for the above example, in year 1, the investor receives $100,000 in principal and the benchmark price of x number of bushels per acre for 100 acres. The number of bushels can be determined in any suitable manner. For example, the number of bushels could be determined based on the farmer's (or previous owner's) historical average yield for that parcel of land.

In some embodiments, a third component can be used in calculating the amount paid by the farmer. This component is the price of the land as compared to a pricing index that tracks farm land pricing. In such an embodiment, the purchase price of the 10 acres of land that is paid down each year is compared to its current value (e.g., value in a most recent index publication, such as yearly property tax value). This identifies any realized gain on the property's value over time.

This calculation can then be used to set the principal payment for the coming year. With regard to the example above, if in year 1, the farmer pays $100,000 in principal for 10 acres and land prices increase 20%, then in year 2, the farmer will pay $120,000. In some embodiments, decreases in land value can also be used to decrease the principal payment in a similar manner (e.g., if in year 1, the farmer pays $100,000 in principal for 10 acres and land prices increase 20%, then in year 2, the farmer will pay $80,000).

In various embodiments, in order to protect the investor, a floor threshold value may be used to ensure that the value of the land does not exceed a certain value. This may be a yearly floor and may be referenced as a dollar amount or a percentage drop value. This differential in price can also be used instead of the traditional fixed and variable interest rates based off the prime rate. These variable amounts can be treated as a form of interest which allows the farmer to use the amount as a tax deduction under the current tax code.

In various embodiments, in order to protect the farmer, a ceiling threshold value may be used to ensure that the value of the land does not exceed a certain value. This may be a yearly ceiling and may be referenced as a dollar amount or a percentage drop value. In some implementations, the both floor and ceiling threshold values may be utilized.

Using these variable tools, the economics of the farm are tied to the economics of the loan and, therefore, when the farm is doing well, the farmer will pay more and when the farm isn't doing well, the farmer will pay less. Such a system will make farm ownership less risky and cause less loan defaults and, as such, benefits both the farmer and the investor.

In some embodiments, the land value can be determined by using a third party index of land values, such as county tax assessment values of land the county or state uses for calculating property tax. These values can be used by the lender to allow a non-interested third party to make land valuation assessments which would ensure fairness for both the farmer and lender.

In such an embodiment, the cost to the farmer includes a fixed payment component that is 10 acres at the purchase price, and a variable component that is the crop calculus (bushels per acre at a benchmark price) and, optionally, plus the difference between the purchase price and current market value of the 10 acres (e.g., could be evaluated as total parcel cost divided by number of acres being financed).

In some implementations, the number of bushels can be a fixed quantity over the period of the loan or, in some embodiments, the number of bushels could be escalated or deescalated based on various factors, such as for yield increases over time. One metric for determining the number of bushels is to use ⅓ of the bushels that are financed (e.g., 200 acres) as the mechanism for determining the number of bushels.

In the example above, if there are 100 acres financed year 1 and the agreement charges 66 bushels per acre, then the total gross bushels to be paid to the investor is 6,600 bushels. After year 1, the farmer would then amortize 10 acres, which would result in 90 acres financed the next year. The total bushels in year two would equal 5,940.

The index (benchmark price) value for the crop can be from any suitable index. For example, one index that can be used would be the December corn contract price. Further, the farmer could choose to grow something else on their parcel that is not the crop being used for the loan. In such instances, the loan could shift the calculation from the original crop to the new crop or the loan will continue to operate based on the original commodity even though the land is being used for a different crop.

In the following portion of the detailed description, reference is made to the accompanying figures that form a part hereof. The figures show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

Also, as used herein, “a” or “a number of” something can refer to one or more such things. For example, “a number of components” can refer to one or more components.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

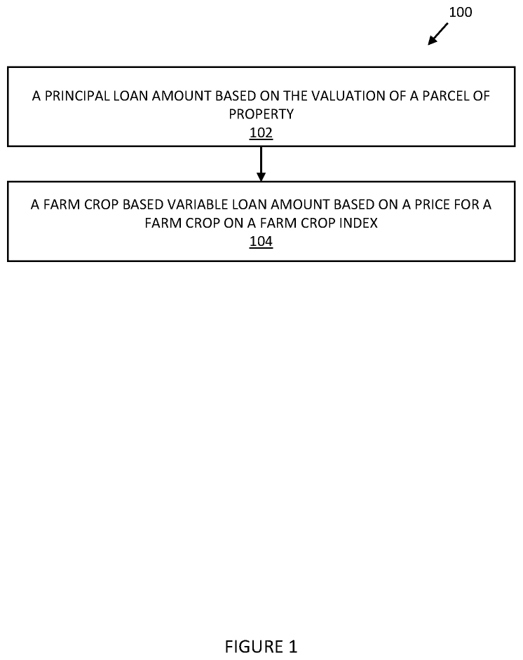

FIG. 1 illustrates an example of the components of a financial instrument for facilitating farm lending according to one or more embodiments of the present disclosure. As discussed above, a financial instrument can have a number of components.

Two such components are illustrated in FIG. 1. In this figure, the financial instrument 100 includes a first component 102 that determines the value of the real estate and a second component 104 that determines the crop value to be paid as part of the loan payment.

Specifically, at 102, FIG. 1 provides the first component as a principal loan amount based on the valuation of a parcel of property. This can be a combination of the original property value and the increase or decrease from year to year, as described above.

At 104, FIG. 1 provides a second component which is a farm crop based variable loan amount based on a price for a farm crop on a farm crop index. This component varies from one period to another (e.g., year to year) as the price of the crop, used in the financial instrument, changes value.

In some embodiments, the financial instrument can further include a parcel value variable loan amount based on a comparison of an initial parcel value at a loan commencement date (e.g., the date the loan was closed) and a parcel value at a subsequent date. The subsequent date can be any suitable date. For example, the parcel value can be recalculated in one year increments if such a timeframe is agreeable to the parties of the loan.

Further, the parcel value can be calculated using any suitable data. For example, a third party index of real estate values, such as values from government index of real estate values like state or county property tax records would be suitable in some implementations.

As discussed above, in some embodiments, at least a portion of the farm crop based variable loan amount is based on a number of bushels of a farm crop. This portion of the loan amount can be set in any suitable way that is tied to the price of the crop. For example, a suitable amount can be determined from based on a third party index for the crop, as discussed above. For instance, a value based on a number of bushels of a farm crop based on a contract price for that farm crop can be used which can be provided by the third party index.

Further, the number of bushels to be used can be determined in any suitable manner. For example, this can be accomplished, by determining the number of bushels based on analysis of previous seasonal yields of bushels of the farm crop on the parcel. Another manner of determining a variable loan amount is to use a monetary value of a percentage of a crop yield for the parcel.

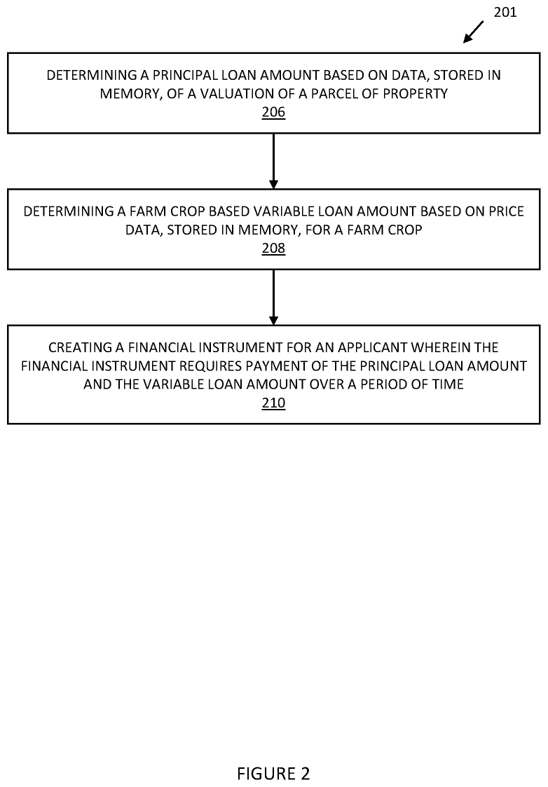

FIG. 2 illustrates an example of a method for facilitating farm lending according to one or more embodiments of the present disclosure. In the example of FIG. 2, the method can be used to form a financial instrument similar to that of FIG. 1.

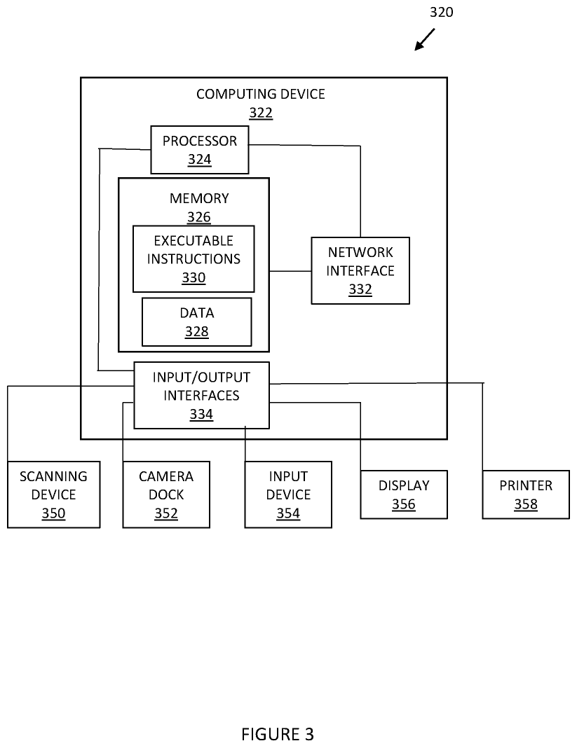

Specifically, the method 201 of FIG. 2 provides, at 206, determining a principal loan amount based on data (e.g., 328 of FIG. 3), stored in memory (e.g., 326 of FIG. 3), of a valuation of a parcel of property. At 208 of FIG. 2, the method also includes determining a farm crop based variable loan amount based on price data (e.g., 328), stored in memory (e.g., 326), for a farm crop. The example method of FIG. 2 also includes creating a financial instrument for an applicant wherein the financial instrument requires payment of the principal loan amount and the variable loan amount over a period of time, at 210.

In some embodiments, the computer implemented method shown in FIG. 2 further includes dividing the financial instrument into a number of segments each containing a portion of the principal loan amount and the farm crop based variable loan amount. The number and length of the segments can be any suitable number and length. For example, if the term of the financial instrument is 10 years, it could be divided into 10 segments, each with a year in duration.

At the end of a segment, it may be a suitable time for an analysis to be performed to ensure that the farmer has made payments as scheduled under the terms of the financial instrument and the principal loan amount and farm crop based variable loan amount can be recalculated. Then, at the start of the next segment, the payment owed by the farmer will be different for the duration of that segment.

Further, as discussed herein, in some embodiments, determining a farm crop based variable loan amount based on price data, stored in memory, for a farm crop includes determining a number of bushels of a farm crop at a set price to be used to determine the farm crop based variable loan amount. In some implementations, the number of bushels to be used to determine the farm crop based variable loan amount can be reduced as an applicant (the farmer) makes payments to a lender of the financial instrument. For example, in some implementations, the number of bushels to be used to determine the farm crop based variable loan amount can be reduced based on the percentage of a number of segments paid off by an applicant as compared to the total number of segments. In this manner, the burden on the farmer can be reduced as the loan is paid down. To accomplish such functions, the lender can utilize a computing system as shown in FIG. 3.

FIG. 3 illustrates a system for facilitating farm lending according to one or more embodiments of the present disclosure. In the system illustrated in FIG. 3, the system 320 includes a computing device 322 having a number of components coupled thereto. The computing device 322 includes a processor 324 and memory 326. The memory 326 can include various types of information including data 328 and executable instructions 330 discussed herein.

Memory and/or the processor may be located on the computing device 322 or off the device in some embodiments. As such, as illustrated in the embodiment of FIG. 3, a system can include a network interface 332. Such an interface can allow for processing on another networked computing device or such devices can be used to obtain information about the applicant, the property (as referred to herein as a parcel) to be subject to the loan, or executable instructions for use with various embodiments provided herein.

As illustrated in the embodiment of FIG. 3, a system can include one or more input and/or output interfaces 334. Such interfaces can be used to connect the computing device with one or more input or output devices. These devices can be used to receive or access data that can be used to accomplish the functions described herein.

For example, in the embodiment illustrated in FIG. 3, the system 320 can include connectivity to a scanning device 350, a camera dock 352, an input device 354 (e.g., a keyboard, mouse, etc.), a display device 356 (e.g., a monitor), a printer 358, and one or more other input devices. The input/output interface 334 can receive data, storable in the data storage device (e.g., memory 326), for example, representing the size of the parcel to be mortgaged, the applicant's personal information and/or loan details, the index rates for the crop being used to determine the loan parameters, and/or the index rate for the parcel, among other information.

In some embodiments, the scanning device 350 can be configured to scan one or more documents containing information pertaining to the loan, such as a loan application or other documents utilized in the process. The scanning device 350 can be configured to input data to the application modules 336.

The camera dock 352 can receive an input from an imaging device (e.g., a two-dimensional imaging device) such as a digital camera or a printed photograph scanner. The input from the imaging device can be stored in the data storage device (e.g., memory 326).

The processor 324 can be configured to execute instructions stored in memory to determine values to be used in the loan and can provide those details to a display 356 (e.g., on a GUI running on the processor 324 and visible on the display 356). Input received, for example, from the applicant or loan processor via the GUI can be sent to the processor 324 as data and/or can be stored in memory 326.

Such connectivity can allow for the input and/or output of data and/or instructions among other types of information. Although some embodiments may be distributed among various computing devices within one or more networks, such systems as illustrated in FIG. 3 can be beneficial in allowing for the capture, calculation, and/or analysis of information discussed herein.

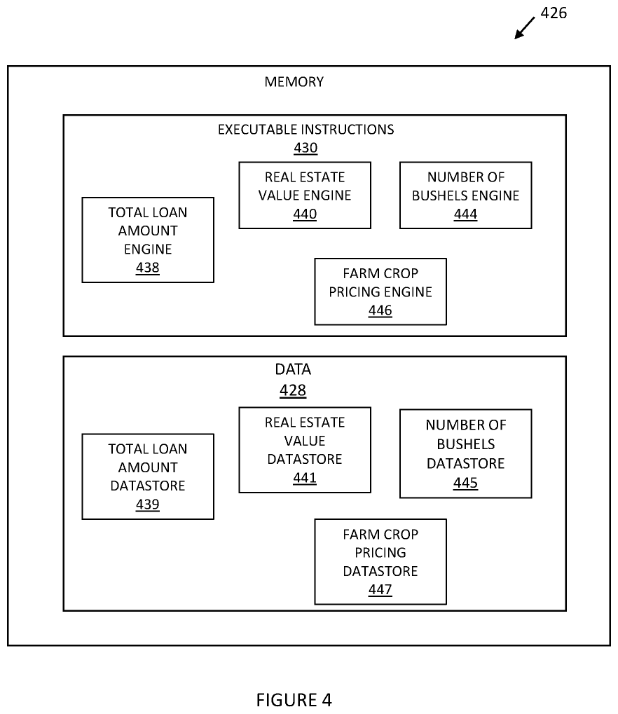

FIG. 4 illustrates sets of executable instructions and data that can be used to provide the functionalities according to one or more embodiments of the present disclosure. In FIG. 4, a number of sets of executable instructions, referred to herein as engines, are used to accomplish the various functionalities of embodiments of the present disclosure. This is accomplished by a processor (e.g., processor 324) executing these instructions in association with data in a data storage device (e.g., memory 326).

The sets of instructions can be grouped (referred to herein as engines) into functionalities that they provide to the system, such as a principal loan amount engine 428, a real estate value engine 440, a number of bushels engine 444, and a farm crop pricing engine 446. These sets of instructions use data to make determinations and provide functions that benefit the system.

The real estate value engine 440 handles the determination of the value of the real estate (i.e., the parcel). This engine uses data regarding the valuation data it has available about the parcel to determine the principal loan amount used to create the total loan amount calculated by the total loan amount engine 438.

The number of bushels engine 444 can be used to determine the number of bushels from the total number of bushels available on the parcel. The analysis can include data about prior year/prior owner yields, national/local yield averages, or other useful data that can be beneficial for determining the number of bushels to be included in the calculation of the total loan amount by the total loan amount engine 438.

The farm crop pricing engine 446 determines the price to use for valuing the number of bushels. As described herein, this can include data from third party indexes or from other resources that can be used to determine a price for the crop. This price can, in turn be used in the computation of the total loan amount by the total loan amount engine 438. The data to be used by these engines can be stored in memory.

For example, such data can include total loan amount data in datastore 439, real estate value data in datastore 441, number of bushel data in datastore 445, and farm crop pricing data in datastore 447.

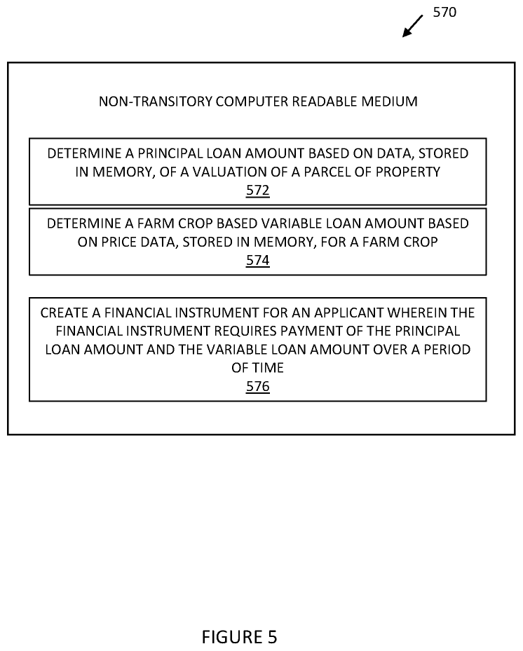

FIG. 5 illustrates an example of a computer readable medium having a set of executable instructions for facilitating farm lending according to one or more embodiments of the present disclosure. In the embodiment of FIG. 5, the instructions in the computer readable medium 570 (e.g., memory 326 of FIG. 3) includes steps to create a financial instrument as described in embodiments of the present disclosure. Specifically, at 572, the instructions execute to determine a principal loan amount based on data, stored in memory, of a valuation of a parcel of property. The instructions also execute to determine a farm crop based variable loan amount based on price data, stored in memory, for a farm crop, at 574. And his data is used by executable instructions to create a financial instrument for an applicant wherein the financial instrument requires payment of the principal loan amount and the variable loan amount over a period of time, at 576.

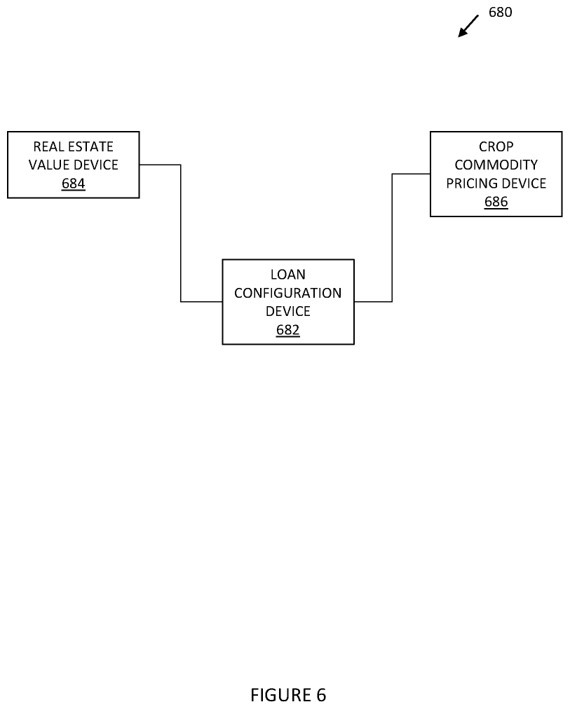

FIG. 6 illustrates a system that provides data and executable instructions for creating a financial instrument according to embodiments of the present disclosure. In FIG. 6, the illustration includes three components, however, there can be several device components that provide data necessary to creating such a financial instrument and those shown in FIG. 6 are merely provided to illustrate a basic system that could be utilized.

In FIG. 6, the system 680 includes a loan configuration device. The loan configuration device 682 is the device that receives data from various resources and creates the financial instrument as discussed above. An example of such a device is computing device 322 of FIG. 3.

Further, FIG. 6 includes a real estate value device 684 that provides information such as a value of the parcel on which the loan is to be obtained or a change in value over a particular period. An example of such a device could be a computer in a county government office that tracks real estate values or changes thereto from year to year.

Lastly, the system 680 of FIG. 6 includes a crop commodity pricing device 686 that provides pricing information used to establish the value of the bushels for the loan. An example of such a device could be a device at a commodity exchange such as the Chicago Board of Trade that tracks crop commodity pricing daily.

The information from devices 684 and 686 is then used by executable instructions on the loan configuration device 682 to determine values for the loan and create the financial instrument based on those determinations. This device can also include instructions for performing the loan application, approval, and/or closing functions.

As discussed above, the methods, devices, financial instruments, and systems for facilitating farm lending disclosed herein can provide many benefits. The benefits can be helpful to the farmer and the lender making such lending solutions favorable to all parties involved in the transaction.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A financial instrument, comprising:
a principal loan amount based on the valuation of a parcel of property; and
a farm crop based variable loan amount based on a price for a farm crop on a farm crop index.

2. The financial instrument of claim 1, further including a parcel value variable loan amount based on a comparison of an initial parcel value at a loan commencement date and a parcel value at a subsequent date.

3. The financial instrument of claim 1, further including a parcel value variable loan amount based on a differential between an initial parcel value at a loan commencement date and a parcel value from a third party index of real estate values.

4. The financial instrument of claim 1, wherein at least a portion of the farm crop based variable loan amount is based on a number of bushels of a farm crop at a set price determined by a third party index for the crop.

5. The financial instrument of claim 1, wherein at least a portion of the farm crop based variable loan amount is based on a number of bushels of a farm crop and wherein the number of bushels is determined based on analysis of previous seasonal yields of bushels of the farm crop on the parcel.

6. The financial instrument of claim 1, wherein at least a portion of the farm crop based variable loan amount is a monetary value of a percentage of a crop yield for the parcel.

7. The financial instrument of claim 1, wherein at least a portion of the variable loan amount is a value based on a number of bushels of a farm crop based on a contract price for that farm crop.

8. A computer implemented method for creating a financial instrument, comprising:
determining a principal loan amount based on data, stored in memory, of a valuation of a parcel of property; and
determining a farm crop based variable loan amount based on price data, stored in memory, for a farm crop; and
creating a financial instrument for an applicant wherein the financial instrument requires payment of the principal loan amount and the variable loan amount over a period of time.

9. The computer implemented method of claim 8, further including determining a change in the variable loan amount based on a comparison of an initial parcel value, stored in memory, for a loan commencement date and a parcel value, stored in memory, for a subsequent date.

10. The computer implemented method of claim 8, further including determining a change in the variable loan amount based on calculating a differential between an initial parcel value at a loan commencement date and a parcel value from a third party index of real estate values at a subsequent date.

11. The computer implemented method of claim 8, further including determining a change in the variable loan amount based on calculating a differential between an initial parcel value at a time the loan was commenced and a parcel value from a government index of real estate values.

12. The computer implemented method of claim 8, further including dividing the financial instrument into a number of segments each containing a portion of the principal loan amount and the farm crop based variable loan amount.

13. The financial instrument of claim 8, wherein determining a farm crop based variable loan amount based on price data, stored in memory, for a farm crop includes determining a number of bushels of a farm crop at a set price to be used to determine the farm crop based variable loan amount.

14. The computer implemented method of claim 13, further including reducing the number of bushels to be used to determine the farm crop based variable loan amount as an applicant makes payments to a lender of the financial instrument.

15. The computer implemented method of claim 14, further including dividing the financial instrument into a number of segments each containing a portion of the principal loan amount and the farm crop based variable loan amount and reducing the number of bushels to be used to determine the farm crop based variable loan amount based on the percentage of a number of segments paid off by an applicant as compared to the total number of segments.

16. A non-transitory computing device readable medium having instructions executable by a computing device to perform a method for creating a financial instrument, comprising instructions to:
determine a principal loan amount based on data, stored in memory, of a valuation of a parcel of property; and
determine a farm crop based variable loan amount based on price data, stored in memory, for a farm crop; and
create a financial instrument for an applicant wherein the financial instrument requires payment of the principal loan amount and the variable loan amount over a period of time.

17. The medium of claim 16, wherein the instructions further include, when a requirement for payment during a first period is satisfied, the variable loan amount is recalculated.

18. The medium of claim 16, wherein, when a requirement for payment during a first period is satisfied, the instructions execute to obtain a new valuation of the parcel of property and recalculate the variable loan amount based on the new valuation.

19. The medium of claim 16, wherein, when a requirement for payment during a first period is satisfied, the instructions execute to obtain new price data for the farm crop and recalculate the variable loan amount based on the new price data.

20. The medium of claim 16, wherein, when a requirement for payment during a first period is satisfied, the instructions execute to obtain a new valuation of the parcel of property and new price data for the farm crop and recalculate the variable loan amount based on the new valuation and new price data.
